(19) United States
(12) Patent Application Publication
(10) Pub. No.: US 2026/0321128 A1
(43) Pub. Date: Oct. 15, 2026

(54) Active Shooter Defense

(71) Applicants: Ivan Stephan Collins, BOWIE, MD (US); Chanell Speight Collins, Bowie, MD (US)

(72) Inventors: Ivan Stephan Collins, BOWIE, MD (US); Chanell Speight Collins, Bowie, MD (US)

(21) Appl. No.: 19/646,421

(22) Filed: Apr. 13, 2026

Related U.S. Application Data
(60) Provisional application No. 63/789,064, filed on Apr. 15, 2025.

(51) Int. Cl. G08B 29/18; G06Q 50/26; G06V 20/52; G06V 40/16; G08B 27/00

(52) U.S. Cl. CPC G08B 29/188; G06V 20/53; G06V 40/172; G08B 27/001; G06Q 50/265

(57) ABSTRACT

A threat response system and method for a building or venue use distributed microphones, cameras, and optional additional sensors to detect and classify threat events. A control system receives event data, determines an event location and affected zones, assigns a threat level, and automatically initiates a protective response. The response can include actuating door relays or other access-control devices, notifying authorized recipients, updating an authorized mobile application, outputting zone-specific evacuation or shelter guidance through displays and speakers, and communicating with emergency services. Sensor fusion and AI-based decision logic can distinguish a confirmed deadly threat from an uncertain disturbance or lower-level altercation, thereby reducing false alarms and enabling proportional response. The system continues monitoring live data during the event, dynamically updates guidance and lockdown actions as conditions change, and records event data and response actions in an event log.

### CROSS-REFERENCE TO RELATED APPLICATIONS

This application claims the benefit of U.S. Provisional Patent Application No. 63/789,064, filed Apr. 15, 2025, and titled “Active Shooter Defense,” the entire disclosure of which is incorporated herein by reference.

### FIELD OF THE DISCLOSURE

The present disclosure relates generally to emergency response and building security systems and, more particularly, to systems and methods for detecting, classifying, and responding to active threat events within buildings and other monitored venues.

### BACKGROUND

Conventional building alarm systems typically provide a generalized alarm and do not tailor instructions to the actual location, severity, or nature of a detected threat. Existing approaches often depend on manual interpretation and manual communication by administrators or security personnel during rapidly evolving emergencies.

In many facilities, including schools, public venues, and commercial buildings, a generalized alarm may direct occupants toward the danger or may fail to distinguish between a confirmed deadly threat, an unconfirmed disturbance, and a lower-level altercation. Delays in locking selected access points, routing occupants, and communicating actionable information to responders can increase danger.

Accordingly, there remains a need for an integrated threat response system capable of detecting potential threat events, determining an event location and affected zones, assigning a severity level, and automatically initiating differentiated protective actions, including notifications, access-control actions, and occupant guidance.

### SUMMARY

In one aspect, the disclosure provides a threat response system for a building or venue. The system can include one or more microphones, cameras, additional sensors, access-control interfaces, display devices, speakers, network interfaces, and a control system that executes decision logic based on detected event data.

In another aspect, the control system receives event data from one or more threat detection devices, analyzes the event data to determine whether a candidate event satisfies one or more threat criteria, identifies one or more affected zones, assigns a threat level or severity score, selects a protective response, and automatically initiates one or more protective actions.

In further aspects, the protective actions can include controlling one or more door lock relays or other access-control devices, transmitting event-specific notifications to authorized recipients, updating an authorized mobile application, outputting zone-specific evacuation or shelter guidance through display devices and speakers, and automatically communicating with emergency services.

In some embodiments, the system employs AI-based or other decision logic to fuse data from multiple sources, including audio data, image data, motion data, access-control data, panic inputs, and zone status, to improve threat confirmation, reduce false activations, and adapt the protective response as conditions change.

In some embodiments, the system differentiates among higher-severity events, unconfirmed disturbances, and lower-severity altercations. In this way, the system can avoid unnecessary building-wide responses while still prompting targeted review and intervention.

The foregoing and other features will become more apparent from the following detailed description of illustrative embodiments, considered in conjunction with the accompanying drawings.

### BRIEF DESCRIPTION OF THE DRAWINGS

FIG. 1 is a functional block diagram of an exemplary threat response system.

FIG. 2 is a flow diagram of an exemplary threat detection and response method.

FIG. 3 is a schematic zone-response diagram illustrating threat containment, evacuation, and shelter routing within a monitored facility.

FIG. 4 is a schematic interface view of an exemplary authorized mobile application.

### DETAILED DESCRIPTION

Reference will now be made in detail to illustrative embodiments of the disclosure. Like reference numerals in the figures identify like or corresponding elements.

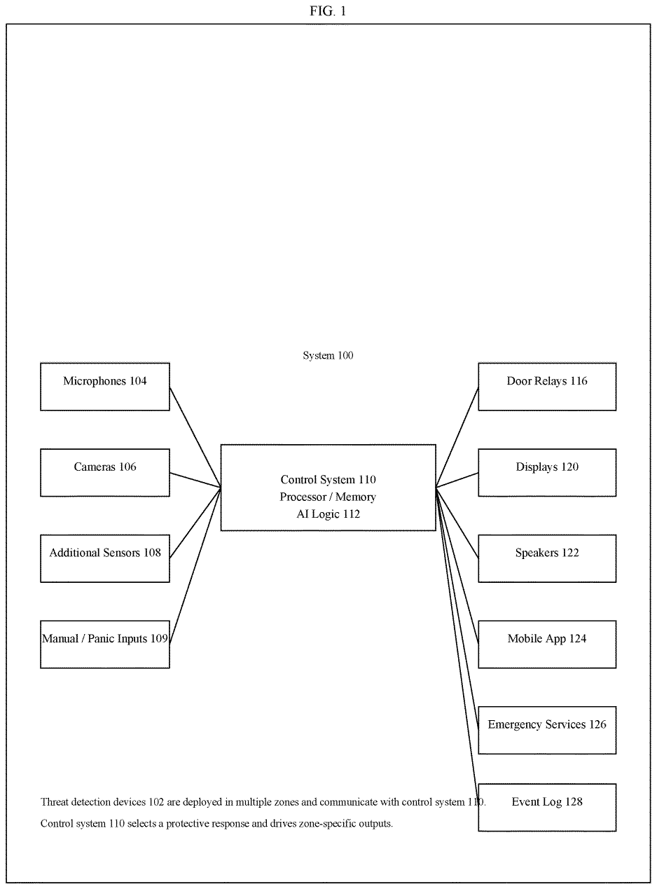

FIG. 1 illustrates an exemplary threat response system 100. System 100 can be deployed in a school, office, retail center, shopping mall, library, public venue, or other building or campus environment. The system 100 can include a plurality of threat detection devices 102 distributed across different rooms, corridors, entrances, and zones.

The threat detection devices 102 can include one or more microphones 104 configured to detect gunshots, gunshot-like sounds, screaming, yelling, impact sounds, or other acoustic signatures. The threat detection devices 102 can also include one or more cameras 106 configured to provide image data corresponding to monitored zones.

The threat detection devices 102 can further include one or more additional sensors or inputs 108, including motion sensors, proximity sensors, panic buttons, administrative manual triggers, access-control events, door status sensors, or gunshot detection sensors. In some embodiments, the system can operate from one or more of the foregoing inputs rather than requiring every type of input.

The system 100 can further include a control system 110 having at least one processor 111, memory 113, and one or more communication interfaces 115. The control system 110 can communicate with the threat detection devices 102 over one or more wired and/or wireless networks, including Ethernet, Wi-Fi, application programming interfaces, text messaging systems, phone systems, or other network-connected infrastructure.

The memory 113 can store program instructions, building maps, zone definitions, access-control data, recipient lists, response rules, historical event data, device status data, and one or more AI or decision logic modules 112. In some embodiments, the AI or decision logic modules 112 include rule-based logic, pattern recognition logic, chatbot-based communication logic, facial recognition logic, computer vision logic, or combinations thereof.

The control system 110 can receive event data from the plurality of threat detection devices 102 and analyze the event data to determine whether a candidate event satisfies one or more threat criteria associated with an emergency condition. For example, the control system 110 can compare received audio data to a gunshot signature, compare image data to one or more weapon or subject indicators, correlate data received from multiple zones, and evaluate system status and timing data.

In some embodiments, the control system 110 uses sensor fusion to combine audio, video, motion, location, and access-control data to confirm or further characterize a detected event. By correlating data from multiple inputs, the system can improve reliability, reduce false activations, and produce more useful event-specific information.

The control system 110 can identify a location of the detected event and determine one or more affected zones. The location can correspond to a hallway, cafeteria, entrance area, lobby, classroom area, retail corridor, food court, store entrance, public concourse, or other monitored zone. Affected zones can include the origin zone, neighboring zones, controlled-access corridors, and candidate evacuation routes.

The control system 110 can assign a severity score or threat level based on one or more event factors. Example factors include a detected gunshot signature, a number of detected impulses within a defined time window, corroborating camera data, visible weapon indicators, crowd behavior, affected zone count, sensor confidence levels, and whether the event is confirmed, suspected, uncertain, or resolved.

Based on the location and assigned threat level, the control system 110 can select and automatically initiate a protective response. In some embodiments, a higher-severity response is triggered when audio matches a gunshot signature above a confidence threshold and is corroborated by camera data or additional sensor data. In some embodiments, a lower-severity or verification response is selected when the event is uncertain or when corroborating imminent-danger indicators are absent.

The protective response can include control of one or more door relays or access-control devices 116. The door relays or access-control devices 116 can lock selected doors, unlock selected doors, restrict movement into or through certain zones, isolate a danger area, or preserve egress routes away from the danger area.

The protective response can also include output to one or more display devices 120 and one or more audio output devices 122. The display devices 120 can include hallway monitors, room displays, wayfinding signs, or other visible notification interfaces. The audio output devices 122 can include speakers or other devices that provide audible instructions.

In some embodiments, the display devices 120 and audio output devices 122 provide zone-specific guidance rather than a generalized building-wide alarm. For example, a first zone may receive shelter-in-place instructions, while a second zone receives evacuation directions toward a safer exit that does not require travel through the threat zone.

The system 100 can further include a notification interface 118 configured to notify authorized recipients, such as administrators, security personnel, faculty, staff, tenants, venue managers, or first responders. The notifications can be transmitted through text messaging, phone systems, chatbot-based communications, application programming interfaces, or other available channels.

The system 100 can also update one or more authorized mobile application clients 124. The mobile application clients 124 can reside on smartphones, tablets, or other mobile computing devices. In some embodiments, the mobile application automatically receives and displays threat detections, affected zone data, lockdown status, door status, route guidance, and response updates in real time.

The system 100 can further include an emergency services interface 126 configured to automatically communicate with law enforcement, emergency responders, or other designated external services. The transmitted data can include a facility identifier, detected event location, affected zones, threat classification, severity score, and system status.

The control system 110 can maintain ongoing monitoring after the initial protective response is triggered. As new camera, microphone, and sensor data are received, the control system 110 can update the threat status, revise the affected zones, change the access-control pattern, update wayfinding instructions, and transmit revised notifications.

The system 100 can further maintain an event log 128. The event log 128 can store event data, timestamps, triggered actions, notifications, confidence scores, override actions, and resolution data for review, reporting, evidentiary use, training, or system improvement.

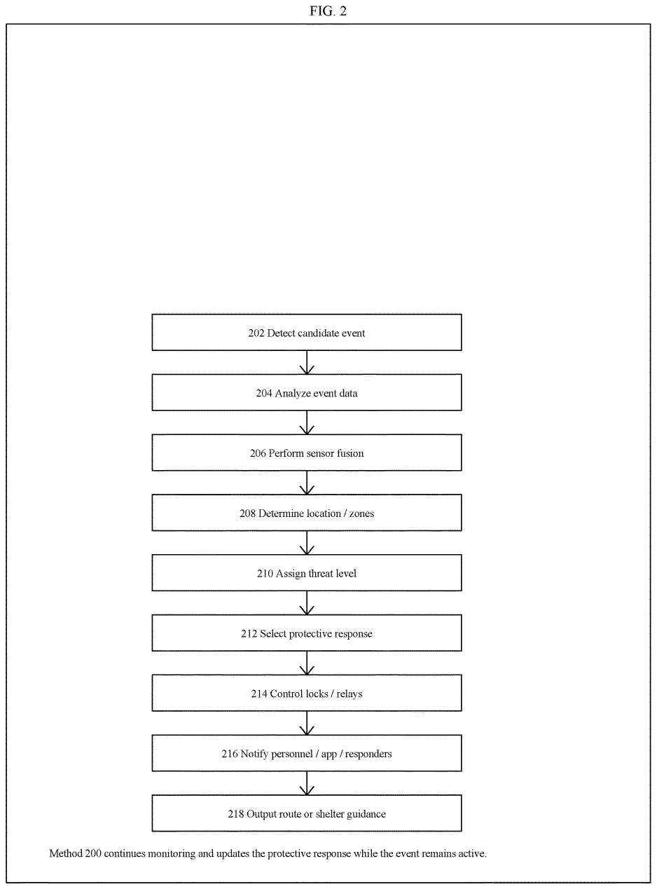

FIG. 2 illustrates an exemplary method 200 for responding to a threat event. At step 202, one or more sensors detect a candidate event, such as a gunshot, gunshot-like sound, loud threatening sound, screaming, or other defined disturbance. At step 204, the system analyzes the event data to determine whether one or more threat criteria are satisfied.

At step 206, the system optionally performs sensor fusion by correlating audio data, camera data, motion data, access-control events, zone triggers, or other available data. At step 208, the system determines an originating location and one or more affected zones. At step 210, the system assigns a severity score or threat level.

At step 212, the system selects a protective response. At step 214, the system can actuate one or more access-control devices, including door relays, locks, gates, or other controlled barriers. At step 216, the system transmits internal notifications to authorized personnel. At step 218, the system updates the authorized mobile application. At step 220, the system communicates with emergency services or designated external responders. At step 222, the system outputs evacuation guidance or shelter guidance through one or more displays or speakers.

At step 224, the system continues to monitor live data and dynamically updates the protective response as conditions change. At step 226, the system maintains the protective response until the event is cleared, reset, or overridden by authorized personnel. At step 228, the system stores event logs and associated records.

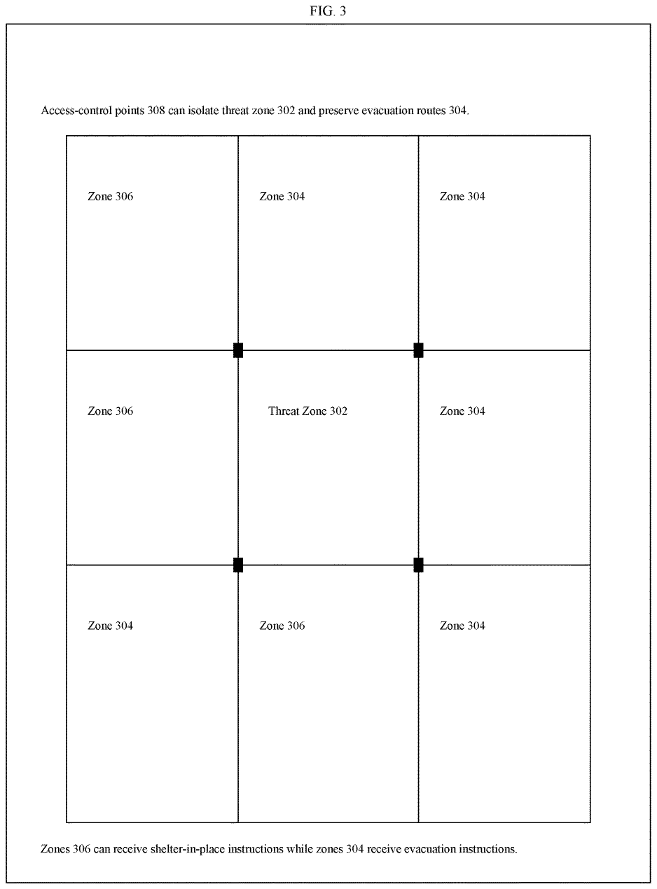

FIG. 3 illustrates a schematic zone-response embodiment 300. A threat zone 302 can correspond to the detected origin of the event. Access-control points 308 can be actuated to isolate or contain the threat zone 302. One or more evacuation routes 304 can be designated for zones determined to be outside the threat path, while one or more shelter zones 306 can be designated for zones proximate to or bounded by the threat zone 302.

In some embodiments, the protective response is dynamically revised as the threat location changes. If the threat moves from one zone to another, the system can revise the identified threat zone 302, actuate a different set of access-control points 308, redirect occupants along a different evacuation route 304, or change a previously designated evacuation zone to a shelter zone 306.

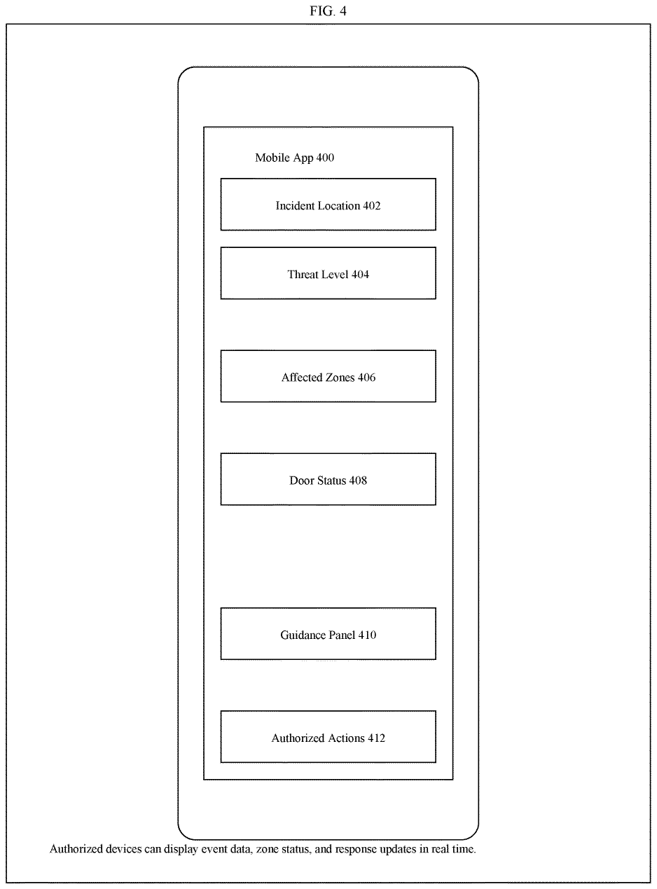

FIG. 4 illustrates an exemplary authorized mobile application 400. The mobile application can display an incident location 402, a threat level 404, an affected-zone list 406, an access-control status 408, one or more route or instruction panels 410, and one or more authorized action controls 412. The application can automatically update as new system data is received.

In some embodiments, the decision logic distinguishes between a confirmed deadly threat, an unconfirmed disturbance, and a lower-level altercation. For example, the system can classify a hallway event involving screaming but lacking a gunshot, visible weapon, attacker identification, or crowd-flight pattern as an unconfirmed disturbance rather than as an active firearm discharge event.

In some embodiments, the system enters a verification sequence when a disturbance is uncertain. During the verification sequence, the system can continue monitoring live camera and microphone data, transmit a verification request to authorized personnel, maintain a restricted or limited response posture, and defer a full lockdown or building-wide evacuation until corroborating imminent-danger indicators are present or an authorized user confirms the event.

In some embodiments, the system classifies a physical altercation between two individuals as a lower-level threat condition when aggressive behavior is detected but no gunshot, visible weapon, firearm discharge event, or other corroborating imminent-danger indicator is present. In such embodiments, the system can transmit targeted alerts to administrators or security staff while refraining from a building-wide lockdown.

In some embodiments, authorized users can override or modify the system response. Override behavior can include escalating a suspected event to a confirmed threat, suppressing a false positive, maintaining or clearing a lockdown state, or modifying zone-specific response actions or occupant guidance.

The system can be deployed in school environments, including hallways, classrooms, cafeterias, and campus buildings. The system can also be deployed in non-school environments, including shopping malls, retail centers, plazas, entertainment venues, libraries, office buildings, transportation facilities, or other public or private spaces.

In an exemplary school hallway event, an active shooter enters a hallway and fires a gun. One or more microphones detect the gunshot, one or more cameras capture image data associated with the event, and the control system classifies the event as an active firearm discharge event and assigns a high-severity threat level. The system then locks electronically controlled doors leading into the affected hallway, transmits event-specific alerts to administrators, security personnel, and responders, updates hallway and classroom displays to provide route-specific instructions, broadcasts tailored audible commands, and continues updating instructions as the threat location changes.

In an exemplary cafeteria event, an active shooter enters a cafeteria during an occupied period and fires a gun. The control system identifies the cafeteria as the incident origin zone, initiates a lockdown sequence for the cafeteria and adjacent corridors, sends event-specific notifications through the mobile application and other interfaces, outputs shelter or evacuation guidance according to recipient zone, and dynamically revises the response if the shooter leaves the cafeteria and enters another area.

In an exemplary false-alarm event, loud screaming is detected in a hallway but no actual threat is present. The control system initially classifies the event as a potential threat event, then analyzes audio characteristics, image data, and related sensor information and determines that no gunshot, weapon, attacker, or emergency crowd-flight pattern is present. The system then classifies the event as an unconfirmed disturbance, transmits a verification alert to authorized personnel, refrains from initiating a full lockdown, and closes the event if an authorized user confirms that the individuals are playing and no threat exists.

In an exemplary lower-level altercation event, the system detects a fight between two individuals in a hallway, lobby, or classroom entrance area. Cameras and microphones capture aggressive movement, yelling, or impact sounds, but the system does not detect a weapon, gunshot, or other imminent deadly threat indicator. The system assigns a lower-severity incident level, sends a targeted alert to designated administrators or security personnel, and continues monitoring without initiating a building-wide lockdown unless the event escalates.

In an exemplary shopping-mall event, an active shooter fires a gun within a mall corridor, food court, store entrance area, or other public zone. The control system identifies the mall incident zone, classifies the event as an active firearm discharge event, transmits location-specific emergency alerts to mall security and responders, actuates available access-control points or barriers to isolate the danger area, provides zone-specific shelter or evacuation instructions to mall occupants and tenants, and updates the response if the shooter moves to another mall zone.

Although the embodiments above describe particular arrangements and sequences, one or more functions can be combined, separated, omitted, reordered, or implemented by different combinations of hardware and software. Likewise, the described components can be integrated into a single platform or distributed among multiple computing devices, servers, controllers, or network-connected subsystems.

Unless otherwise indicated, the terms “comprising,” “including,” and similar terms are intended to be open-ended. The foregoing description is illustrative and not limiting, and the scope of protection is defined by the claims.

1. A threat response system for a building or venue, comprising: a plurality of threat detection devices disposed in different zones of the building or venue and including at least one microphone and at least one camera; one or more display devices and one or more audio output devices located within the building or venue; one or more electronically controllable door relays configured to control respective access points; and a control system comprising at least one processor and memory storing instructions that, when executed, cause the control system to: receive event data from the plurality of threat detection devices corresponding to a detected threat event; determine, based on the event data, a location of the detected threat event and at least one affected zone; assign a threat level to the detected threat event; select a protective response based on the location and the threat level; actuate at least one of the door relays according to the protective response; transmit notification data identifying the location and the threat level to authorized recipients; cause at least one of the display devices and at least one of the audio output devices to present zone-specific evacuation guidance or shelter-in-place guidance; and continue to update the protective response as new event data is received.

2. The system of claim 1, wherein the event data comprises an audio signature corresponding to a gunshot or gunshot-like sound detected by the at least one microphone.

3. The system of claim 1, wherein the plurality of threat detection devices further includes at least one of a panic input, a manual administrative trigger, a motion sensor, a proximity sensor, a door status sensor, or a gunshot detection sensor.

4. The system of claim 1, wherein the control system is configured to perform sensor fusion by correlating audio data with image data from the at least one camera and with at least one additional sensor input before assigning the threat level.

5. The system of claim 1, wherein the control system includes decision logic configured to classify the detected threat event as a threat event, a non-threat event, or an uncertain event.

6. The system of claim 1, wherein the threat level comprises a severity score determined from at least one of sound characteristics, a number of detected impulses within a defined time window, location data, affected-zone data, and corroborating sensor information.

7. The system of claim 1, further comprising an authorized mobile application configured to automatically receive and display real-time event information including at least one of threat detection data, lockdown status, door status, affected-zone data, and response updates.

8. The system of claim 1, wherein the control system is configured to automatically communicate with law enforcement, emergency responders, or other designated external services and provide incident-related information including at least one of the location, the affected zone, the threat level, and a system status.

9. The system of claim 1, wherein the one or more display devices comprise hallway monitors or wayfinding displays configured to present route-specific instructions directing occupants away from the location of the detected threat event.

10. The system of claim 1, wherein the control system permits an authorized override operation including at least one of escalating a suspected event to a confirmed threat, suppressing a false positive, maintaining or clearing a lockdown state, or modifying zone-specific guidance.

11. A computer-implemented method for responding to a threat event within a monitored building or venue, the method comprising: detecting, by one or more sensors, a candidate threat event; analyzing event data associated with the candidate threat event to determine whether the candidate threat event satisfies one or more threat criteria; identifying one or more affected zones and assigning a threat level; automatically initiating a protective response including at least one of (i) actuating an access-control device, (ii) transmitting notifications to authorized recipients, (iii) updating a mobile client, and (iv) outputting zone-specific evacuation guidance or shelter guidance through a display or speaker system; continuing to monitor live data and dynamically updating the protective response as conditions change; and logging event data, timestamps, and actions associated with the protective response.

12. The method of claim 11, wherein detecting the candidate threat event comprises detecting a gunshot in a hallway and initiating the protective response without waiting for manual confirmation.

13. The method of claim 11, wherein analyzing the event data comprises determining that screaming has been detected in a hallway while no gunshot, visible weapon, identified attacker, or corroborating emergency crowd-flight pattern is present, and classifying the candidate threat event as an unconfirmed disturbance.

14. The method of claim 13, further comprising transmitting a verification alert to authorized personnel and refraining from initiating a full building-wide lockdown until corroborating imminent-danger indicators are present or an authorized user confirms the threat event.

15. The method of claim 11, wherein analyzing the event data comprises determining that a physical altercation between two individuals is present while no weapon, gunshot, or other imminent deadly threat indicator is detected, and assigning a lower-severity incident level.

16. The method of claim 11, further comprising revising a locked-door pattern and changing output guidance when the location of the threat event changes from a first zone to a second zone.

17. The method of claim 11, wherein the output guidance is differentiated by recipient zone such that a first zone receives shelter-in-place instructions and a second zone receives evacuation instructions.

18. A non-transitory computer-readable medium storing instructions that, when executed by at least one processor, cause a control system to: receive audio data, camera data, and additional sensor data associated with a candidate threat event within a monitored building or venue; determine whether the candidate threat event is likely a threat, a non-threat, or an uncertain event; determine an affected zone and a threat level; initiate an event-specific response including notification routing, access-control actions, and occupant guidance; and update a mobile application and an emergency-services communication channel with incident data corresponding to the candidate threat event.

19. The non-transitory computer-readable medium of claim 18, wherein determining whether the candidate threat event is likely a threat further comprises applying at least one of visible weapon detection, facial-recognition-based subject correlation, or crowd-behavior analysis to corroborate the candidate threat event.

20. The method of claim 11, wherein logging event data includes storing a detection time, a lockdown activation time, an alert transmission time, and a route-update time.
